(19) United States
(12) Patent Application Publication
(10) Pub. No.: US 2007/0295283 A1
(43) Pub. Date: Dec. 27, 2007

(54) Sound producing pet toy

(75) Inventor: James W. Gick, Laguna Niguel, CA (US)

Correspondence Address: Crokett & Crockett, Suite 400, 24012 Calle De La Plata, Laguna Hills, CA, 92653, US

(73) Assignee: Pet Qwerks, Inc.

(21) Appl. No.: 11/472,909

(22) Filed: Jun. 22, 2006

(51) Int. Cl. A01K 29/00

(52) U.S. Cl. 119/707

(57) ABSTRACT

The methods and devices described provide for a sound producing pet toy with no electrical components.

### FIELD OF THE INVENTIONS

The inventions described below relate the field of pet toys.

### BACKGROUND OF THE INVENTIONS

Pets, such as cats and dogs, which spend a majority of time indoors, are popular. Due to the busy schedules of their owners, however, such pets are spending an increasing amount of time alone indoors when their owners are not present. While having healthy and happy pets is important to pet owner, the ability of pet owners to exercise and play with their pets is sometimes limited.

Many different pet toys are available to pet owners to assist them in keeping their pets happy and healthy. Different types of balls, bones and other toys can be purchased by the owner for use by their pets' during exercise and enjoyment. Many of these devices produce sound through motion sensing means coupled with an electronic sound producing means as part of an integrated circuit. These devices require power sources such as batteries that can run out of power quickly. Further, if these devices become wet during use by a pet, they may be rendered inoperable. When these electronic sound producing pet toys can no longer produce sound due to their drawbacks, pets may quickly lose interest in them. Thus, the pets will not benefit from exercise and enjoyment

What is needed is durable sound producing pet toy that does not rely on electronic components. The devices and methods described in this application address the drawback of electronic sound producing pet toys.

### SUMMARY

The methods and devices described below provide for one or more sound producing apparatus. The sound producing pet toy contains no electrical components. It comprises a housing provided in a variety of shapes, including a ball, a sphere, a square, a football shape, an animal face, or other shape having a weight, a bladder and a reed in fluid communication with the bladder disposed therein. When the sound producing pet toy is in use, movement of the housing may produce a sound. The weight inside the housing compresses the bladder which forces air through the sound device when the device is moved. By moving the device, for example turning it over and over quickly, the device produces an attractive animal sound for pets.

### BRIEF DESCRIPTION OF THE DRAWINGS

FIG. 1 shows a pet toy in the shape of a ball.

FIG. 2 is an exploded view of the pet toy of FIG. 1.

FIG. 3 shows the pet toy comprising a plush ball having soft filler material.

### DETAILED DESCRIPTION OF THE INVENTIONS

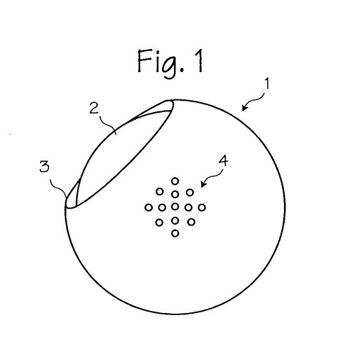

FIG. 1 shows a pet toy 1 in the shape of a ball. If the toy moves or is turned over and over a weight dispose within the housing compresses a bladder within the housing forcing air through a reed that emits sound. Thus, the toy will stimulate or attract a pet and increase the likelihood that the pet will play with the toy.

The pet toy comprises a housing 2 and one or more sound producing apparatus disposed within the housing. The sound producing apparatus contains a bladder, a reed, whistle or other sound-producing device or instrument utilizing fluid to produce a sound, in fluid communication with the bladder and a weight disposed above the bladder. The toy's housing 2 may be provided in a variety of shapes, including a ball, a square, a football shape, an animal face, or other shape, though preferably the toy should have the ability to roll. The outer layer 3 or skin may be made of plastic, rubber or any durable or pliable material that resists damage from being chewed by an animal. The outer layer 3 may also be made of a soft material ideal for children to grab and hold. The toy 10 may include various holes 4 that allow sound to pass from a reed or whistle located inside the toy 1 to the outside environment. The pet toy 1 may be manufactured in various different sizes and the housing may be constructed using separately manufactured sections that are coupled together.

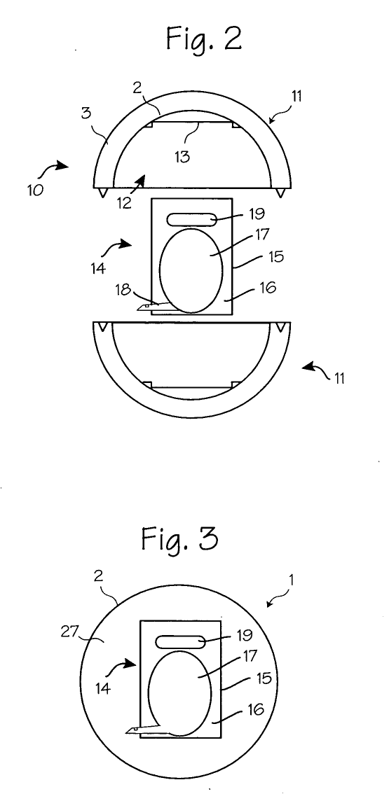

FIG. 2 is an exploded view of the pet toy of FIG. 1. With reference to FIG. 2, a first shell half 9 and a second shell half 10 are joined to establish an outer surface 11 of the housing 2 of the toy 1. The outer surface 11 of the two shell halves may be covered by the outer skin 3, as shown in FIG. 1. The assembled shell halves define a cavity 12 within, and may be easily formed with conventional injection molding techniques.

The first shell half has a sound producing apparatus receptacle 13 to hold at least one producing apparatus 14. The second shell half also has a sound producing apparatus receptacle 13 to hold the sound producing apparatus in place within the housing when halves are coupled together. The sound producing apparatus 14 comprises a closed cylinder 15 or other shape with a chamber 16 containing the bladder 17, the reed or whistle 18 in fluid communication with the bladder and the weight 19 disposed above the bladder 17. The weight 19 is free to move up and down the cylinder 15 depending on the weight's position and the force of gravity. When the weight 19 is positioned below the bladder 17, the weight 19 moves to the bottom of the cylinder 15, allowing the bladder 17 to expand and fill up with air. When the weight is positioned above the bladder 17 filled with air, the weight 19 moves to the bottom of the cylinder compressing the bladder 17. The compression of the bladder forces air through the reed or whistle 18 thus producing a sound. The bladder 17 may be manufactured from an elastomer such as latex or other polymer that allows the bladder to expand and contract. The reed or whistle may be manufactured from a resilient material such as metal or plastic and is shaped in such a way as to produce a noise when air is blown through it. The weight 19 may contain sand, metal or plastic beads or be of a solid material so long as it is of sufficient weight as to compress the bladder 17 when it is disposed above the bladder 17.

The two shell halves 9 and 10 are held together to form a ball shape. This may be accomplished through the use of fasteners, adhesives or a combination thereof. Appropriate fasteners may include slip-fit fittings, screws, pins, snaps or a screw/thread pattern molded into the first and second shell halves 9 and 10. The two shell halves 9 and 10 may also be held together to form a ball shape with a glue and/or and epoxy applied to the outer edges of each shell half or by other suitable means for fixing the shell halves together.

FIG. 3 illustrates the pet toy wherein the housing comprises a soft plush outer shell filled with a soft filler material 27 and the sound producing apparatus disposed within the padding. The housing may in FIG. 3 may be manufactured from a pliable material such as naturally produced fabrics including cotton, wool, felt or synthetically produced fabrics including faux fur or polyester. The shell is filled with the filler material. The filler material creates an affect that is tactilely pleasing and dampens the forces transferred to the sound producing apparatus when the toy is used in a rough manner. The material may comprise soft materials such as cotton, foam, poly fiber materials beads. the sound producing apparatus is disposed within the housing.

In use, the pet toy 1 is moved or rolled over and over by a pet such as a dog or cat. The bladder 17 within the sound producing apparatus is filled with air. When the weight 19 is placed above the bladder when the ball is rolled, the weight 19 moves towards the bottom of the cylinder 15 and compressed the bladder 17. This forces air out of the bladder 17 through the whistle 18 creating an attractive noise for the pet. When the pet toy 1 is rolled in such a manner as to position the weight below the bladder, the bladder is able to expand filling the bladder with air. Thus, the process may be repeated wherein the weight is placed above and below the bladder when the toy is rolled. This alternating positioning of the weight allows for compressing and expanding of the bladder producing an attractive noise through the whistle for pets. The toy is able to provide both entertainment and exercise to the family pet. Since the toy has no electrical components, there is no need for batteries that can run out of power. Further, since the device relies on mechanical devices, it may be subjected to environments harsher than those of electronic pet toys.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. A sound producing pet toy comprising:
a spherical housing;
and a sound producing apparatus disposed within the housing;
wherein the sound producing apparatus comprises a chamber with a bladder, a reed in fluid communication with said bladder and a weight disposed above said bladder.

2. The sound producing toy of claim 1 wherein the housing comprises a first shell and a second shell.

3. The sound producing pet toy of claim 1 further comprising an outer layer of durable material disposed over the housing.

4. The sound producing pet toy of claim 1 further comprising a plurality of holes sized and dimensioned to permit sound to travel from within the housing to the outside environment.

5. A method of producing sound with a pet toy comprising:
providing a pet toy having a spherical housing and a sound producing apparatus disposed within the housing wherein the sound producing apparatus comprises a chamber with a bladder, a whistle in fluid communication with said bladder and a weight disposed above said bladder; and
rolling the spherical housing on a surface in a manner as to place the weight above the bladder thereby compressing the bladder and forcing air through the whistle creating sound.

6. A sound producing pet toy comprising:
a fabric housing;
a soft filler material disposed with in the housing
and a sound producing apparatus disposed within the filler material;
wherein the sound producing apparatus comprises a chamber with a bladder, a reed in fluid communication with said bladder and a weight disposed above said bladder.
